(19) United States
(12) Patent Application Publication
(10) Pub. No.: US 2026/0312489 A1
(43) Pub. Date: Oct. 8, 2026

(54) DAMPING-DISCONNECT CIRCUIT FOR A POWER CONVERTER

(71) Applicant: Eaton Intelligent Power Limited, Dublin (IE)

(72) Inventors: Hua Qiang Li, Menomonee Falls, WI (US); Mahesh Mysore Swamy, Gurnee, IL (US)

(21) Appl. No.: 19/098,677

(22) Filed: Apr. 2, 2025

(51) Int. Cl. H02M 1/44; H02M 5/458

(52) U.S. Cl. CPC H02M 1/44; H02M 5/458

(57) ABSTRACT

A system includes: a filter apparatus including a plurality of phases, each phase of the filter apparatus including: a first node, a second node, and a filter circuit between the first node and the second node, each first node is configured to electrically connect to one phase of a multi-phase alternating current (AC) electrical power source, and each filter circuit includes a capacitive network. The system also includes a power converter electrically connected to the second nodes and configured to produce an output when in an ACTIVE state and to not produce the output when in an INACTIVE state; and a damping-disconnect circuit electrically connected to the filter apparatus and configured to reduce a circulating current in the filter circuit, the damping-disconnect circuit including a plurality of silicon-controlled-rectifiers (SCRs), each SCR coupled to the capacitive network of one filter circuit.

### TECHNICAL FIELD

This disclosure relates to a damping-disconnect circuit for a power converter.

### BACKGROUND

A power converter may include, for example, an active front end (AFE) or a matrix converter. The power converter may be connected to an alternating current (AC) high-power electrical distribution system, such as a power grid, or to another AC source. The power converter drives, powers, and/or controls a machine, or a non-machine type of load.

### SUMMARY

In one aspect, a system includes: a filter apparatus including a plurality of phases, each phase of the filter apparatus including: a first node, a second node, and a filter circuit between the first node and the second node, each first node is configured to electrically connect to one phase of a multi-phase alternating current (AC) electrical power source, and each filter circuit includes a capacitive network. The system also includes a power converter electrically connected to the second nodes and configured to produce an output when in an ACTIVE state and to not produce the output when in an INACTIVE state; and a damping-disconnect circuit electrically connected to the filter apparatus and configured to reduce a circulating current in the filter circuit, the damping-disconnect circuit including a plurality of silicon-controlled-rectifiers (SCRs), each SCR coupled to the capacitive network of one filter circuit.

Implementations may include one or more of the following features.

The plurality of SCRs may transition from an OFF state to an ON state in response to the power converter transitioning from the INACTIVE state to the ACTIVE state. The damping-disconnect circuit also may include a plurality of switches, each of the plurality of switches electrically connected to a gate of one of the plurality of SCRs, and each of the plurality of switches may be open when the electrical network is in the INACTIVE state and each of the plurality of switches may close in response to the electrical network transitioning to the ACTIVE state to thereby turn on the plurality of SCRs. Each switch may include a mechanical contactor. Each switch may include an SCR.

The damping-disconnect circuit also may include a plurality of diodes, each of the plurality of diodes electrically connected to an anode of one of the SCRs.

The power converter may be configured to convert alternating current (AC) to direct current (DC) and to convert DC current to AC current.

The power converter may include an active front end (AFE) and an inverter.

The power converter may include a matrix converter.

The damping-disconnect circuit also may include a damping resistance. The damping resistance may include a plurality of damping resistances, and each of the plurality of damping resistances may be electrically connected to one of the capacitive networks and at least one of the SCRs. Each of the plurality of damping resistances may be electrically connected between one of the capacitive networks and one of the SCRs. The damping resistance may include a plurality of damping resistances and each filter circuit also may include an inductive network, and each of the plurality of damping resistances may be electrically connected in parallel to one of the inductive networks.

The system also may include a control apparatus configured to output a trigger signal to the damping-disconnect circuit to actuate a plurality of switches to thereby turn on the SCRs in response to an operational status of the power converter. The control apparatus may be configured to output the control signal to the damping system when the power converter is transitioned to the ACTIVE state.

The damping-disconnect circuit may be configured to prevent current from flowing in the filter circuits when the electrical network is in the INACTIVE state.

The damping-disconnect circuit also may include a positive temperature coefficient circuit configured to attenuate current flowing in the filter circuits when the electrical network is in the INACTIVE state.

In another aspect, a system includes: a damping-disconnect circuit configured for connection to a filter circuit of a power converter, the damping-disconnect circuit including: a plurality of silicon-controlled-rectifiers (SCRs), each SCR configured to be electrically connected to a capacitive network in one phase of a multi-phase filter apparatus; and a plurality of switches, each switch configured to turn ON a respective SCR of the plurality of SCRs in response to a trigger signal. The damping-disconnect circuit is configured to eliminate or attenuate circulating current in the filter circuit.

The damping-disconnect circuit also may include at least one damping resistor configured to dissipate the circulating current.

In another aspect, a control system is configured to: determine whether an alternating current (AC) source electrically connected to a filter circuit of a power converter is in a fault condition; if the AC source is not in a fault condition, determine whether the power converter is in a READY state; if the power converter is in the READY state, causing a thyristor in the damping-disconnect circuit to be ON such that current from the filter circuit flows in the damping-disconnect circuit; and if the power converter is not in the READY state, causing the thyristor in the damping-disconnect circuit to be OFF.

Implementations of any of the techniques described herein may include an apparatus, a device, a system, and/or a method. The details of one or more implementations are set forth in the accompanying drawings and the description below. Other features will be apparent from the description and drawings, and from the claims.

### DRAWING DESCRIPTION

FIG. 1 is a block diagram of a power system.

FIG. 2A is a schematic of a system.

FIG. 2B is a schematic of a damping-disconnect circuit.

FIG. 3A is a schematic of another system.

FIG. 3B is a schematic of another damping-disconnect circuit.

FIG. 4 is a schematic of another damping-disconnect circuit.

FIG. 5 is a schematic of another damping-disconnect circuit.

FIG. 6 is a schematic of another damping-disconnect circuit.

FIGS. 7A and 7B show simulated results of a system.

FIG. 7C is a schematic of the system simulated to produce the data shown in FIGS. 7A and 7B.

FIG. 8 is a schematic of a system that includes a health monitoring circuit.

FIG. 9 is a flow chart of a process for controlling silicon controlled rectifiers in a damping-disconnect circuit.

### DETAILED DESCRIPTION

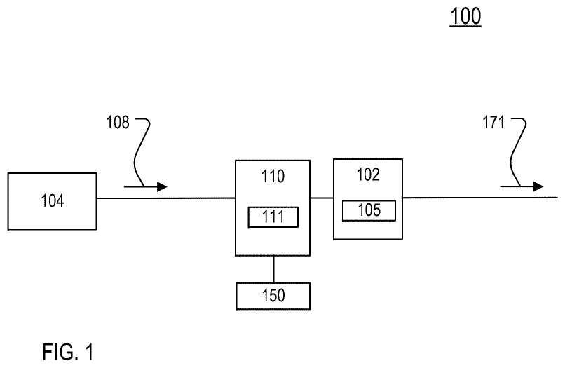

FIG. 1 is a block diagram of a power system 100. The power system 100 includes a power converter 102 that is electrically connected to an alternating current (AC) electrical source 104. The AC source 104 is any type of source of AC or time-varying electrical power. For example, the AC source 104 may be a node in an AC power grid or distribution network, or a DC to AC converter, or an output of an AC electrical apparatus, such as a transformer or voltage regulator. In some implementations, the AC source 104 is a multi-phase electrical power grid that provides electricity to industrial, commercial and/or residential customers with a fundamental frequency of, for example, 50 or 60 Hertz (Hz) and may have an operating voltage of, for example, up to 690V.

The power converter 102 provides power 171 for a load (not shown) based on AC electrical power 108 from the AC source 104. The power converter 102 may be, for example, an active front end (AFE), a matrix converter, a four-quadrant variable speed drive (VSD). The power converter 102 includes controllable switches 105 (for example, transistors) that are switched on and off at relatively high frequencies in accordance with a switching pattern to control a load (not shown)-. The switching pattern may be, for example, based on a pulse width modulation (PWM) control scheme.

The power converter 102 also includes a filtering circuit 110. The filtering circuit 110 reduces high-frequency noise that can arise from the switching action and mitigates the potential effects of the noise on the AC source 104 and/or devices connected to the AC source 104 while also providing an interface to connect the power converter 102 to the AC source 104. The filtering circuit 110 includes a filtering network 111. The filtering network 111 includes a capacitive network and may include one or more inductors. For example, the filtering network 111 may be an inductor-capacitor (LC) filter or an inductor-capacitor-inductor (LCL) filter.

The power converter 102 has an ACTIVE state, an INACTIVE state, and an OFF state. In the ACTIVE state, the controllable switches 105 are switched on and off in accordance with the switching pattern to provide the power 171 for the load. In the INACTIVE state, the power converter 102 is powered but the switches 105 are not switched based on the switching pattern, and the converter 102 does not provide the power 171 for the load. The INACTIVE state also may be referred to as an IDLE state or a STANDBY state. In the OFF state, the power converter 102 does not receive power and does not provide the power 171 for the load.

In practice, once the power converter 102 is electrically connected to the AC source 104, it is seldom turned OFF because cycling power to the power converter 102 is typically not recommended. Thus, the filtering network 111 remains electrically connected to the AC source 104 and draws current such that a circulating current flows in the filtering circuit 110 even when the power converter 102 is in the INACTIVE state. The circulating current causes loss. In addition, the capacitors in the filtering network draw leading power factor current which could possibly interact unfavorably with other loads on the AC grid, resulting in poor power quality at the input AC terminals of the AC grid. If there are multiple active filter-based converters on the AC grid, the interactions among the filter capacitors could lead to system resonance that could result in a system outage. To reduce this loss and to save energy, the filtering network 111 is connected to a damping-disconnect circuit 150 that reduces or eliminates the circulating current that would otherwise flow within the filtering network 111. By reducing or eliminating the circulating current, the damping-disconnect circuit 150 improves the overall efficiency of the system 100, reduces heat produced by the system 100, and improves the overall performance of the system 100.

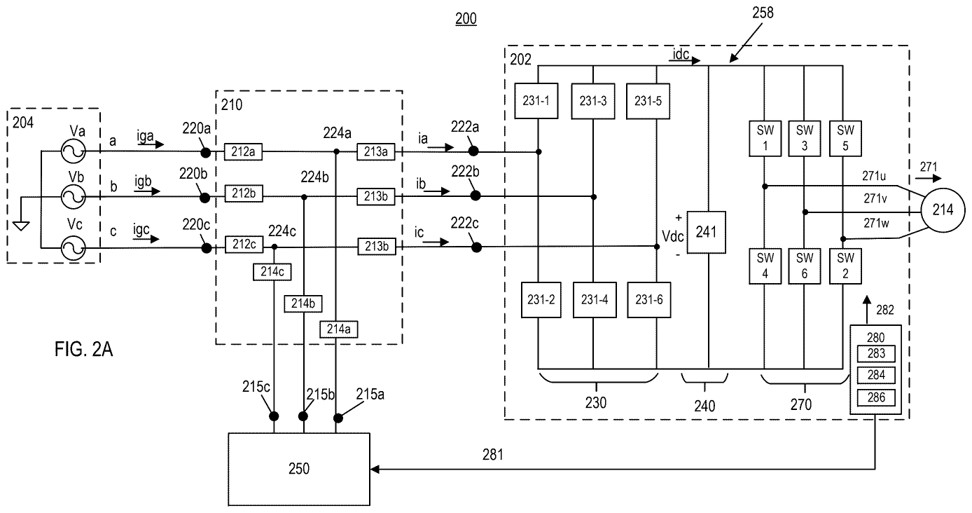

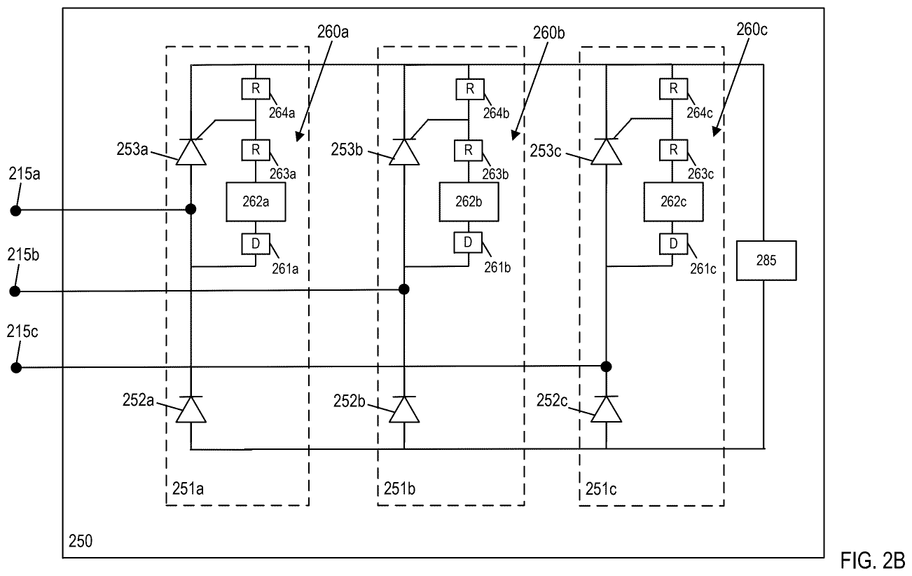

FIG. 2A is a schematic of a system 200. The dashed lines in FIG. 2A are used to show groupings of elements, and the dashed lines do not necessarily represent physical objects. However, the power converter 202 may be in a housing or enclosure, such as a rack-mountable box or a cabinet. The system 200 includes a power converter 202, a three-phase AC power source 204, a filtering circuit 210, and a damping-disconnect circuit 250 that is electrically connected to the filtering circuit 210. The power converter 202 is electrically connected to the filtering circuit 210 and a load 214, which may be, for example, an induction motor or a permanent magnet synchronous machine. The filtering circuit 210 is electrically connected to the AC power source 204 and the power converter 202.

The AC power source 204 includes three phases, which are referred to as a, b, and c. Each phase a, b, c has a respective source voltage Va, Vb, Vc. The AC source 204 is any type of source of alternating current (AC) or time-varying electrical power. For example, the AC source 204 may be a node in an AC power grid or distribution network, an AC generator, or an output of an AC electrical apparatus, such as a transformer or voltage regulator. In implementations in which the AC source 204 is a power grid, the source 204 provides AC electrical power that has a fundamental frequency of, for example, 50 or 60 Hertz (Hz). The AC source 204 the power grid may include, for example, one or more transmission lines, distribution lines, electrical cables, and/or any other mechanism for transmitting electricity.

The filtering circuit 210 includes input nodes 220a, 220b, 220c, each of which is electrically coupled to one of the three phases (a, b, c) of the AC source 204. The filtering circuit 210 includes a three-phase LCL filter connected to the AC source 204. Phase a of the LCL filter includes a source-side inductor 212a, a converter-side inductor 213a, and a filter capacitor 214a. The source-side inductor 212a is electrically connected to the input node 220a. The converter-side inductor 213a is connected to the intermediate node 222a and to the source-side inductor 212a at a node 224a. Filter capacitor 214a is also connected to node 224a. Each of phases b and c of the LCL filter is configured in the same manner.

FIG. 2B is a schematic of the damping-disconnect circuit 250. As depicted in FIG. 2B, the damping-disconnect circuit 250 includes semiconverter circuits 251a, 251b, 251c. The semiconverter circuit 251a includes a diode 252a and a thyristor 253a. A thyristor includes a cathode, an anode, and a gate. When the cathode is negatively charged relative to the anode, no current flows in the thyristor until current is applied to the gate. When current is applied to the gate, the thyristor conducts current until the voltage between the cathode and the anode is reversed or reduced below a threshold or holding value. The thyristor has three states: forward conducting (current is applied to the gate and the thyristor conducts forward current), forward blocking (the thyristor blocks the flow of forward current despite voltage being applied in a direction that would cause a diode to conduct current), and reverse blocking (the thyristor blocks the flow of reverse current). A silicon-controlled rectifier (SCR) is an example of a thyristor.

In the example of FIG. 2B, the thyristor 253a is an SCR. The semiconverter circuit 251b includes a diode 252b and an SCR 253b, and the semiconverter circuit 251c includes a diode 252c and an SCR 253c. The cathode of the diode 252a is electrically connected to the anode of the SCR 253a. Likewise, the cathode of the diode 252b is electrically connected to the anode of the SCR 253b, and the cathode of the diode 252c is electrically connected to the anode of the SCR 253c.

Each SCR 253a, 253b, 253c is associated with a respective gating circuit 260a, 260b, 260c. The gating circuit 260a includes a diode 261a, a controllable switch 262a, and resistances 263a, 264a. The controllable switch 262a may be an electromechanical switch such as a contactor. Similarly, the gating circuit 260b includes a diode 261b, a controllable switch 262b, and resistances 263b, 263a, and the gating circuit 260c includes a diode 261c, a controllable switch 262c, and resistances 263c, 264c.

Referring to the gating circuit 260a to provide an example, the anode of the diode 261a is electrically connected to the anode of the SCR 253a and the cathode of the diode 261a is electrically connected to the controllable switch 262a. The resistance 263a is connected to the controllable switch 262a, the gate of the SCR 253a, and the resistance 264a. The resistance 264a is also electrically connected to the gate of the SCR 253a. The gating circuits 260b and 260c are arranged in the same manner. A damping resistance 285 is connected in parallel to the semiconverter circuits 251a, 251b, 251c. Specifically, the damping resistance 285 is electrically between the cathodes of the SCRs 253a, 253b, 253c and the anodes of the diodes 252a, 252b, 256c.

Referring again to FIG. 2A, the power converter 202 includes a bidirectional rectifier 230, an energy storage apparatus 240, and an inverter 270. The bidirectional rectifier 230 is a three-phase, active front end (AFE) that includes six electronic switches 231-1 to 231-6 that rectify the AC currents ia, ib, ic into a DC current idc. Each electronic switch 231-1 to 231-6 is any type of controllable electronic switch that has an ON state that conducts current and an OFF state that does not conduct current. For example, each switch 231-1 to 231-6 may be a transistor, such as an insulated gate bipolar transistor (IGBT) or a metal-oxide semiconductor field effect transistor (MOSFET).

The electronic switches 231-1 to 231-6 are also electrically connected to the energy storage apparatus 240, which includes one or more capacitors 241. The rectified current idc flows into the energy storage apparatus 240 and is stored in the capacitor 241. The capacitor 241 is any type of capacitive device and may include more than one capacitive device. In some implementations, the capacitor 241 is an electrolytic capacitor.

The state of each electronic switch 231-1 to 231-6 is controlled by a control system 280. For example, in implementations in which the switches 231-1 to 231-6 are transistors, the control system 280 may control the state of a particular transistor by controlling a voltage source (not shown) or other element to thereby control the voltage at the gate of that transistor. The control system 280 generates a control signal 282 that, when provided to the bidirectional rectifier 230, controls the electronic switches 231-1 to 231-6 based on a pulse width modulation (PWM) control scheme. The control system 280 is also configured to output a READY signal 281 when the bidirectional rectifier 230 is transitioned from an INACTIVE state to an ACTIVE state, by an external command.

The inverter 270 includes a network of electronic switches SW1 to SW6. Each switch SW1 to SW6 may be, for example, a power transistor. The inverter 270 includes output terminals 271u, 272v, 272w, each of which is connected to one of the three phases of the load 214. The control signal 282 from the control system 280 also controls the switching of the electronic switches SW1 to SW6 based on a PWM control scheme to control the voltage across the terminals 271u, 271v, 271w to power the load 214.

The discussion above relates to providing an AC output 271 to the load 214. However, the power converter 202 may be bi-directional. In implementations in which the power converter 202 is bi-directional, the control system 280 controls the electronic switches 231-1 to 231-6 and SW1 to SW6 such that power can flow from the load 214 to the AC source 204. Thus, energy generated by the load 214 may be returned to the AC source 204 through the bi-directional power converter 202. Furthermore, the power converter 202 is provided as an example, and other configurations are possible. For example, the bi-directional power converter 202 may be implemented without the inverter 270 and configured to drive a DC load.

The control system 280 includes an electronic processing module 283, an electronic storage 284, and an input/output (I/O) interface 286. The control system 280 may be implemented as a microcontroller or a logic controller. The electronic processing module 283 includes one or more electronic processors. The electronic processors of the module 283 may be any type of electronic processor and may or may not include a general-purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 284 may be any type of electronic memory. In some implementations, the electronic memory is capable of storing instructions in the form of computer programs or software. The electronic storage 284 may include volatile and/or non-volatile components. The electronic storage 284 and the processing module 283 are coupled such that the processing module 283 is able to access or read data from and write data to the electronic storage 284. The electronic storage 284 stores instructions that, when executed, cause the electronic processing module 283 to analyze data and/or retrieve information.

The I/O interface 286 is any interface that allows a human operator, another device, and/or an autonomous process to interact with the control system 280. The I/O interface 286 may include, for example, pins, ports, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 286 also may allow communication without physical contact through, for example, an IEEE 802.11, Bluetooth, or a near-field communication (NFC) connection. The control system 280 and/or the information stored on the electronic storage 284 may be, for example, operated, configured, modified, or updated through the I/O interface 286.

The I/O interface 286 also may allow the control system 280 to communicate with components in the system 200 and with systems external to and remote from the system 200. For example, the I/O interface 286 may include a communications interface that allows communication between the control system 280 and a remote station (not shown), or between the control system 280 and a separate monitoring apparatus. The remote station or the monitoring apparatus may be any type of station through which an operator is able to communicate with the control system 280 without making physical contact with the control system 280. For example, the remote station may be a computer-based workstation, a smart phone, tablet, or a laptop computer that connects to the control system 280 via a services protocol, or a remote control that connects to the control system 280 via a radio-frequency signal.

In operational use, the power converter 202 is electrically connected to the AC source 204 through the filtering circuit 210, as shown in FIG. 2A. The damping-disconnect circuit 250 is electrically connected to the filtering circuit 210, with each filter capacitor 214a, 214b, 214c being electrically connected to a respective one of the semiconverter circuits 251a, 251b, 251c of the damping-disconnect circuit 250. Specifically, the filter capacitor 214a is electrically connected to the cathode of the diode 252a, the anode of the SCR 253a, and the anode of the diode 261a of the semiconverter circuit 251a; the filter capacitor 214b is electrically connected to the cathode of the diode 252b, the anode of the SCR 253b, and the anode of diode 261b of the semiconverter circuit 251b; and the filter capacitor 214c is electrically connected to the cathode of the diode 252c, the anode of the SCR 253c, and the anode of the diode 261c of the semiconverter circuit 251c.

Once the power converter 202 has been connected to the AC source 204, it is seldom placed in the OFF state. Instead, when the AC output 271 is not needed, the power converter 202 is placed in the INACTIVE state. When the power converter 202 is not in the ACTIVE mode, the controllable switches 262a, 262b, 262c are open and the corresponding gating circuits 260a, 260b, 260c are not energized. Thus, the SCRs 253a, 253b, 253c are OFF. As a result, no current can flow into the wye points 224a, 224b, 224c or the filter capacitors 214a, 214b, 214c.

When the power converter 202 is transitioned to the ACTIVE mode, the READY signal 281 is provided by the control system 280 to the controllable switches 262a, 262b, 262c such that the controllable switches 262a, 262b, 262c turn on. For example, each controllable switch 262a, 262b, 262c may be a contactor which is controlled by a logic circuit that checks for the health of the input AC grid and the status of the READY signal 281 from the control system 280. When both signals are ‘High’, the logic is asserted and the contactors 262a, 262b, and 262c are turned ON. Current flows through the closed controllable switches 262a, 262b, 262c, raising the voltage at the gate of each SCR 253a, 253b, 253c until the SCRs 253a, 253b, 253c turn on. Current then flows through the SCRs 253a, 253b, 253c and into the damping resistance 285. The damping resistance 285 dissipates the current, thereby providing a damping effect to the filter circuit 210.

When the power converter 202 is returned to the INACTIVE state (for example, at the end of a factory shift or at the end of the week), the control system 280 removes or no longer provides the READY signal 281; the switches 262a, 262b, 262c open; and the voltage at the gate of the SCRs 253a, 253b, 253c drops. The SCRs 253a, 253b, 253c turn off and current cannot flow through the wye points 224a, 224b, 224c or the filter capacitors 214a, 214b, 214c. Thus, loss from circulating currents that would otherwise flow in the filter capacitors 214a, 214b, 214c when the power converter 202 is in the INACTIVE state is reduced or eliminated by the damping-disconnect circuit 250. In other words, turning off the SCRs 253a, 253b, 253c to stop current from flowing through the filter capacitors 214a, 214b, 214c during times when the power converter 202 is not in the ACTIVE state saves energy that could otherwise be lost due to circulating current in the source-side inductors 212a, 212b, 212c and the filter capacitors 214a, 214b, 214c.

Moreover, the loss that may be caused by current flowing in the damping-disconnect circuit 250 is less than a legacy approach that uses a transistor such as an insulated gate bipolar transistor (IGBT) to bring a damping resistance into and out of electrical circuit with the filtering capacitors 214a, 214b, 214c. Additionally, the current that flows in the gating circuits 260a, 260b, 260c is small (for example, in the ones or tens of milliamps (mA)), thus the controllable switches 262a, 262b, 262c may be relatively small and inexpensive switches with relatively low current ratings. Furthermore, the voltage rating of the controllable switches 262a, 262b, 262c also may be relatively low because the damping-disconnect circuit 250 is electrically connected to the neutral forming connection of the filter capacitor 214a, 214b, 214c. Also, control of each SCR 253a, 253b, 253c is achieved with a voltage divider and a controllable switch functioning as a relay. For example, the state of the SCR 253a is controlled by the voltage divider formed by the resistances 263a, 264a and the controllable switch 262a, the state of the SCR 253b is controlled by the voltage divider formed by the resistances 263b, 264b and the controllable switch 262b, and the state of the SCR 253c is controlled by the voltage divider formed by the resistances 263c, 264c and the controllable switch 262c. This allows control of the SCRs 253a, 253b, 253c without a separate gate driver board. The value of the damping resistance 285 may be two times that needed on the AC side since the damping resistor is on the DC side of the semiconverter bridge. The value of the damping resistance 285 is a function of grid side inductor, converter side inductor, and filter capacitor.

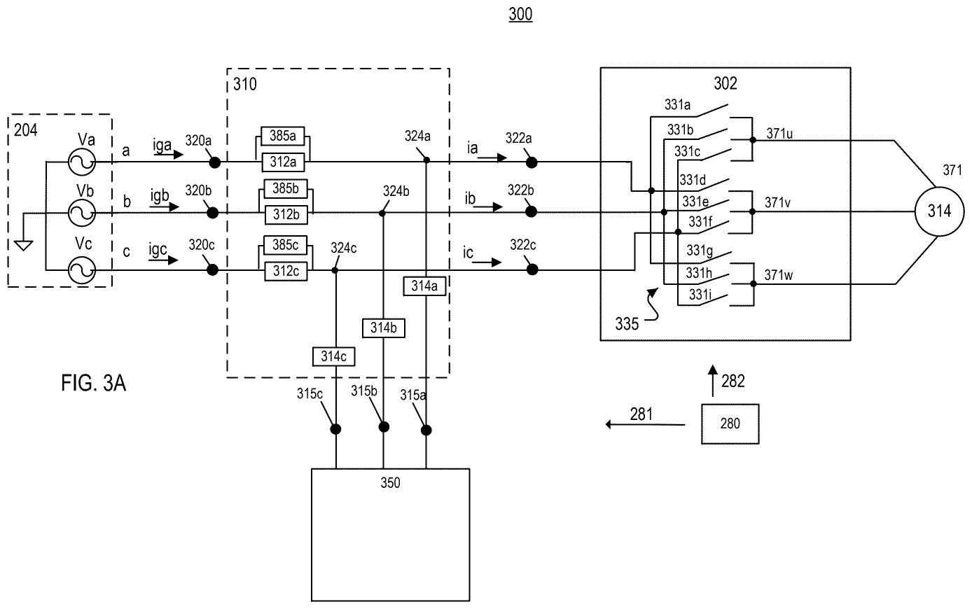

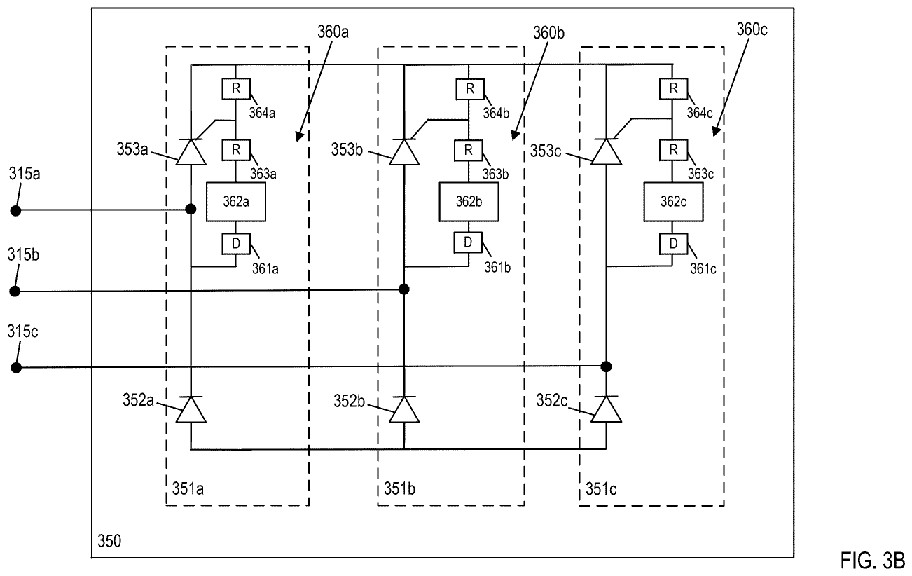

FIG. 3A is a schematic of a system 300 that includes a matrix converter 302, the three-phase AC power source 204, a filtering circuit 310, and a damping-disconnect circuit 350 that is electrically connected to the filtering circuit 310. The matrix converter 302 is a three-phase AC to AC converter that converts an AC input at nodes 322a, 322b, 332c into an AC output at nodes 371u, 371v, 371w. Each terminal 371u, 371v, 371w is connected to one phase of a load 314.

The matrix converter 302 includes a grid 335 of controllable semiconductor switches. The grid 335 shown in the example of FIG. 3A includes nine switches 331a-331i, two in each phase. Each switch 331a-331i is a bi-directional power switch that links the nodes 322a, 322b, 322c to the nodes 371u, 371v, 371w. Each switch 331a-331i may be, for example, two semiconductor devices (for example, IGBTs or MOSFETS) connected in a back-to-back configuration with anti-parallel body diodes. The matrix converter 302 does not include an intermediate DC bus capacitor for energy storage purposes or to link the nodes 322a, 322b, 322c and the nodes 371u, 371v, 371w. The matrix converter 302 relies on a three-phase input LC filter in the filtering circuit 310 for proper operation. Similar to the three-phase LCL filter in the filtering circuit 210, there is non-trivial circulating capacitor current when the matrix converter 302 is idling.

The matrix converter 302 has an ACTIVE state in which the control system 280 generates the control signal 282 to control the switches 331a-331i to switch on and off in a switching pattern that generates voltage at the terminals 371u, 371v, 371w that has an amplitude, phase, and frequency that depends on the characteristics of the switching pattern. The switching pattern may be, for example, based on a PWM control scheme. In an INACTIVE state, the matrix converter 302 may be powered but the control system 280 does not generate the control signal 282. In an OFF state, the matrix converter 302 is not powered and the control system 280 does not generate the control signal 282.

The filtering circuit 310 includes input nodes 320a, 320b, 320c, each of which is electrically coupled to one of the three phases (a, b, c) of the AC source 204. The filtering circuit 310 includes a three-phase LC filter connected to the AC source 204. Phase a of the LC includes a source-side inductor 312a and a filter capacitor 314a. The source-side inductor 312a is electrically connected to the input node 320a and a node 324a. A damping resistance 385a is connected in parallel with the source-side inductor 312a. The filter capacitor 314a is connected in a broken wye configuration at the node 324a. Each of the phases b and c of the LC filter is configured in the same manner. The damping-disconnect circuit 350 also includes damping filter input nodes 315a, 315b, 315c. To connect the damping-disconnect circuit 350 to the filter circuit 310, each damping-disconnect circuit input node 315a, 315b, 315c is connected to a respective filter capacitor 314a, 314b, 314c.

FIG. 3B is a schematic of the damping-disconnect circuit 350. The damping-disconnect circuit 350 is the same as the damping-disconnect circuit 250 (FIG. 2B), except the damping-disconnect circuit 350 does not include a damping resistance. As depicted in FIG. 3B, the damping-disconnect circuit 350 includes semiconverter circuits 351a, 351b, 351c. The semiconverter circuit 351a includes a diode 352a and a thyristor, which is shown as a silicon-controlled rectifier 353a in FIG. 3B. The semiconverter circuits 351b, 351c also include a diode 352b, 352c and SCR 353b, 353c, respectively.

The cathode of the diode 352a is electrically connected to the anode of the SCR 353a. The cathode of the diode 352b is electrically connected to the anode of the SCR 353b, and the cathode of the diode 352c is electrically connected to the anode of the SCR 353c. A gating circuit 360a, 360b, 360c is provided for each SCR 353a, 353b, 353c, respectively. The gating circuit 360a includes a diode 361a, a controllable switch 362a, and resistances 363a, 364a. The controllable switch 362a may be an electromechanical switch such as a contactor. Similarly, the gating circuit 360b includes a diode 361b, a controllable switch 362b, and resistances 363b, 363c and the gating circuit 360c includes a diode 361c, a controllable switch 362c, and resistances 363c, 364c.

In the gating circuit 360a, the anode of the diode 361a is electrically connected to the anode of the SCR 353a and the cathode of the diode 361a is electrically connected to the controllable switch 362a. The resistance 363a is connected to the controllable switch 362a, the gate of the SCR 353a, and the resistance 364a. The resistance 364a is also electrically connected to the gate of the SCR 353a. The gating circuits 360b and 360c are arranged in the same manner. Comparing FIG. 3B to FIG. 2B, it can be seen that the damping-disconnect circuit 350 does not include a damping resistance connected to the cathodes of the SCRs 353a, 353b, 353c. Instead, the damping resistance 385a, 385b, 385c is coupled in parallel with each source-side inductor 312a, 312b, 312c, respectively. Having the damping resistance configured as shown in FIG. 2B may interfere with the proper commutation of the switches 331a-331i of the matrix converter 302. Thus, although three damping resistances 385a, 385b, 385c are shown in FIG. 3B, and the system includes more damping resistances than the implementation shown in FIG. 2A, the configuration shown in FIG. 3B may be more suitable for a system that includes a matrix converter.

Each filter capacitor 314a, 314b, 314c is electrically connected to a respective semiconverter circuit 351a, 351b, 351c. Specifically, the filter capacitor 314a is electrically connected to the cathode of the diode 352a, the anode of the SCR 353a, and the anode of the diode 361a of the semiconverter circuit 351a. The filter capacitors 314b, 314c are connected in a similar manner to the components of the semiconverter circuits 351b, 351c.

The matrix converter 302 is electrically connected to the AC source 204 through the filtering circuit 310, as shown in FIG. 3A. When the matrix converter 302 is not in the ACTIVE state, the controllable switches 362a, 362b, 362c are open and the gating circuits 360a, 360b, 360c are not activated. As such, the SCRs 353a, 353b, 353c are OFF and no current can flow into the wye points 324a, 324b, 324c or the filter capacitors 314a, 314b, 314c.

When the matrix converter 302 is transitioned to an ACTIVE mode, the control system 280 provides the READY signal 281 to the controllable switches 362a, 362b, 362c of the semiconverter circuits 351a, 351b, 351c. The controllable switches 362a, 362b, 362c turn on in response to receiving the READY signal 281. Current flows through the controllable switches 362a, 362b, 362c, raising the voltage at the gate of the SCRs 353a, 353b, 353c and turning on the SCRs 353a, 353b, 353c. Current then flows through the SCRs 353a, 353b, 353, the filter capacitors 314a, 314b, 314c, and the damping resistances 385a, 385b, 385c, thereby providing filtering and damping for the filtering circuit 310.

When the matrix converter 302 is returned to the INACTIVE state, the control system 280 no longer provides the READY signal 281 to the controllable switches 362a, 362b, 362c and the controllable switches 362a, 362b, 362c open, causing the voltage at the gate of the SCRs 353a, 353b, 353c to drop. The SCRs 353a, 353b, 2353c turn off and current cannot flow through the wye points 324a, 324b, 324c or the filter capacitors 314a, 314b, 314c of the filtering circuit 310. Thus, loss from circulating currents that would otherwise flow in the filter capacitors 314a, 314b, 314c when the matrix converter 302 is in the INACTIVE state is reduced or eliminated by the damping-disconnect circuit 350. Turning off the SCRs 353a, 353b, 353c to stop current from flowing through the filter capacitors 314a, 314b, 314c of the filtering circuit 310 during times when the matrix converter 302 is not in the ACTIVE state saves energy that could otherwise be lost due to circulating current in the source-side inductors 312a, 312b, 312c and the filter capacitors 314a, 314b, 314c.

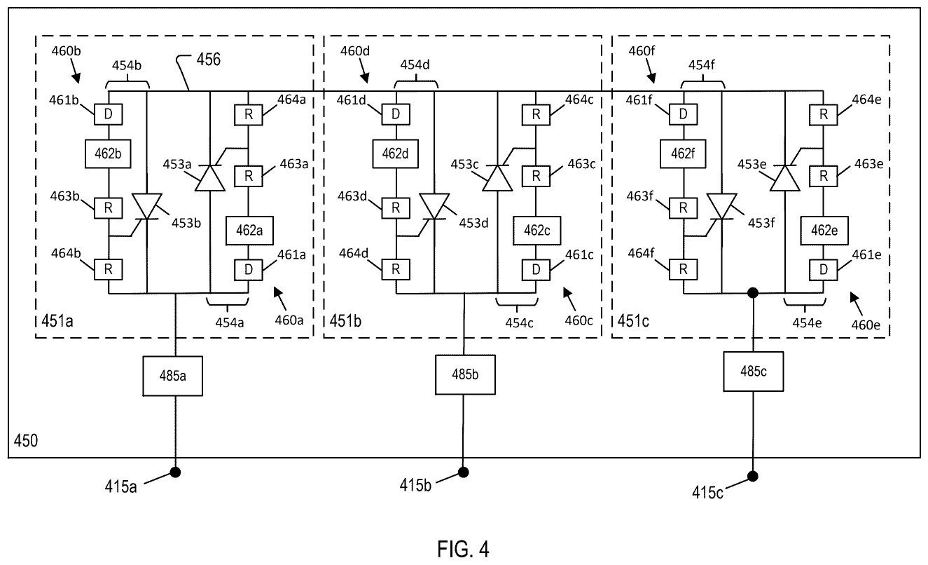

FIG. 4 is a schematic of another damping-disconnect circuit 450. The damping-disconnect circuit 450 may be used, for example, in the system 200 of FIG. 2A instead of the damping-disconnect circuit 250. The damping-disconnect circuit 450 includes back-to-back SCRs connected in parallel to mimic the operation of a mechanical contactor.

In the following discussion, reference will be made to FIG. 4 and FIG. 2A. The damping-disconnect circuit 450 includes semiconverter circuits 451a, 451b, 451c, each of which is connected to a respective damping-disconnect circuit input node 415a, 415b, 415c through a respective damping resistance 485a, 485b, 485c. The semiconverter circuit 451a includes back-to-back SCR circuits 454a, 454b electrically connected in parallel. The SCR circuit 454a includes an SCR 453a and a gating circuit 460a that includes a diode 461a, a controllable switch 462a, and resistances 463a, 464a. Similarly, the SCR circuit 454b includes an SCR 453b and a gating circuit 460b that includes a diode 461b, a controllable switch 462b, and resistances 463b, 464b. The controllable switches 462a and 462b may be, for example, contactors. The anode of the SCR 453a is connected to the damping resistance 485a and the cathode of the SCR 453a is connected to a node 456. The cathode of the SCR 453b is connected to the damping resistance 485a and the anode of the SCR 453b is connected to the node 456.

In the gating circuit 460a of the SCR circuit 454a, the anode of the diode 461a is electrically connected to the damping resistance 485a. The cathode of the diode 461a is electrically connected to the controllable switch 462a. The resistance 463a is electrically connected to the controllable switch 462a, the gate of the SCR 453a, and the resistance 464a. The resistance 464a is electrically connected to the gate of the SCR 453a and the node 456.

In the gating circuit 460b of the SCR circuit 454b, the anode of the diode 461b is electrically connected to node 456. The cathode of the diode 461b is electrically connected to the controllable switch 462b. The resistance 463b is electrically connected to the controllable switch 462b, the gate of the SCR 453b, and the resistance 464b. The resistance 464b is electrically connected to the gate of the SCR 453b and the damping resistance 485a. The semiconverter circuits 451b, 451c are configured in the same manner.

In operation, the damping-disconnect circuit 450 is connected to the filter circuit 210 (FIG. 2A) by electrically connecting the damping-disconnect circuit input node 415a to the capacitor 214a, the damping-disconnect circuit input node 415b to the capacitor 214b, and the damping-disconnect circuit input node 415c to the capacitor 214c. When the power converter 202 is in the INACTIVE state, the control system 280 does not provide a READY signal 281 to the damping-disconnect circuit 450. As a result, the controllable switches 462a, 462b in the gating circuits 460a, 460b of the semiconverter circuit 451a are open, the gating circuits 460a, 460b of the semiconverter circuit 451a are not energized, and the SCRs 453a, 453b are OFF. The controllable switches 462c, 462d in the gating circuits 460c, 460d of the semiconverter circuit 451b and the controllable switches 462e, 462f in the gating circuits 460e, 460f of the semiconverter circuit 451c operate in the same manner such that the SCRs 453c, 453d and SCRs 453e, 453f are OFF. As a result, no current can flow into the wye points 224a, 224b, 224c or the filter capacitors 214a, 214b, 214c of the filtering circuit 210.

When the power converter 202 is transitioned to the ACTIVE mode, the READY signal 281 is provided by the control system 280 to the controllable switches 462a-462f in the damping-disconnect circuit 450, and each of the controllable switches 462a-462f turns on. When the controllable switches 462a-462f are on, current flows through each controllable switch 462a-462f, raising the voltage at the gates of each SCR 453a-453f, respectively, until each SCR 453a-453f turns on. Current then flows through the SCRs 453a-453f, filter capacitors 214a, 214b, 214c, and the damping resistances 485a-c, thereby providing damping for the filtering circuit 210. It also allows the filtering circuit 210 to perform its primary function of filtering the high frequency switching components so that it does not reflect on the AC source 204.

When the power converter 202 is returned to the INACTIVE state, the READY signal 281 is no longer provided to the controllable switches 462a-462f and the controllable switches 462a-462f open. As a result, the voltage at the gate of each SCR 453a-453f drops, the SCRs 453a-453f turn off, and current cannot flow through the wye points 224a, 224b, 224c or the filter capacitors 214a, 214b, 214c of the filtering circuit 210. Thus, loss from circulating currents that would otherwise flow in the filter capacitors 214a, 214b, 214c when the power converter 202 is in the INACTIVE state is reduced or eliminated by the damping-disconnect circuit 450.

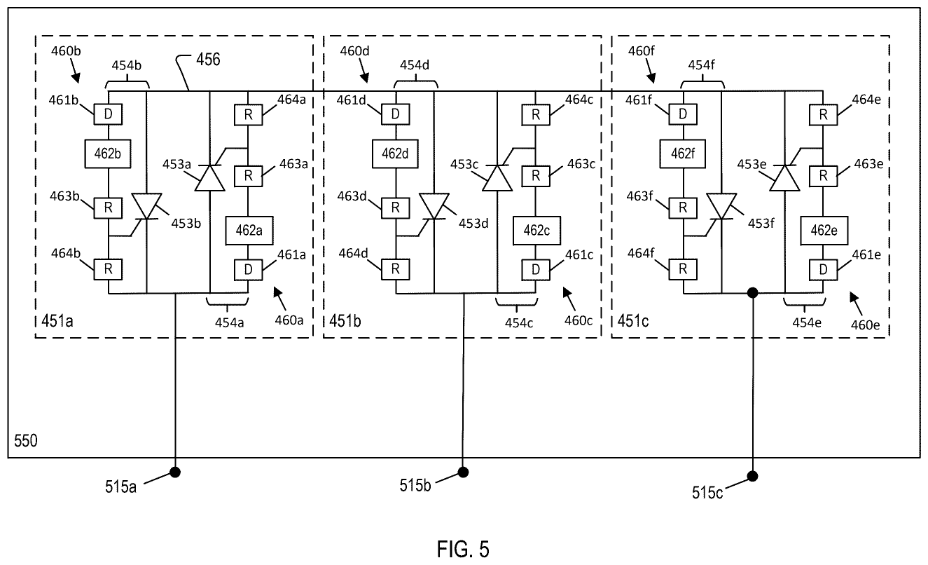

FIG. 5 is a schematic of another damping-disconnect circuit 550. The damping-disconnect circuit 550 is the same as the damping-disconnect circuit 450 (FIG. 4), except the damping-disconnect circuit 550 does not include the damping resistors. The damping-disconnect circuit 550 may be used, for example, with a system that includes a matrix converter such as the system 300 of FIG. 3A. In the following discussion, reference will be made to FIG. 5 and FIG. 2A.

The damping-disconnect circuit 550 is electrically connected to the filter capacitors 314a, 314b, 314c. The damping-disconnect circuit 550 includes the semiconverter circuits 451a, 451b, 451c but does not include damping resistances. Instead, in the damping-disconnect circuit 550, each semiconverter circuit 451a, 451b, 451c is directly connected to a respective damping-disconnect circuit input node 515a, 515b, 515c.

Referring to FIG. 3A and FIG. 5, in operational use, the damping-disconnect circuit 550 is electrically connected to the filter circuit 310 by electrically connecting the damping-disconnect circuit input node 515a to the capacitor 314a, the damping-disconnect circuit input node 515b to the capacitor 314b, and the damping-disconnect circuit input node 515c to the capacitor 314c. When the matrix converter 302 in the INACTIVE mode, the control system 280 does not provide a READY signal 281 to the damping-disconnect circuit 550. As a consequence, the controllable switches 462a, 462b in the gating circuits 460a, 460b of the semiconverter circuit 451a are open, the gating circuits 460a, 460b of the semiconverter circuit 451a are not energized, and the SCRs 453a, 453b are OFF. The controllable switches 462c, 462d in the gating circuits 460c, 460d of the semiconverter circuit 451b and the controllable switches 462e, 462f in the gating circuits 460e, 460f of the semiconverter circuit 451c operate in the same manner such that the SCRs 453c-453f are also OFF. As a result, no current can flow into the wye points 324a, 324b, 324c or the filter capacitors 314a, 314b, 314c of the filtering circuit 310.

When the matrix converter 302 is transitioned to an ACTIVE mode, the control system 280 provides the READY signal 281 to each of the controllable switches 462a-462f in the damping-disconnect circuit 450, and all of the controllable switches 462a-462f turn on. When the controllable switches 462a-462f are on, current flows through each controllable switch 462a-462f, raising the voltage at the gates of each SCR 453a-453f, until each of the SCRs 453a-453f turn on. Current subsequently flows through the SCRs 453a-453f, filter capacitors 314a, 314b, 314c, and the damping resistances 385a, 385b, 385c, thereby providing damping for the filtering circuit 310. It also allows the filtering circuit 310 to perform its primary function of filtering the high frequency switching components so that it does not reflect on the AC source 204.

When the matrix converter 302 is returned to the INACTIVE state, the control system 280 does not provide the READY signal 281 to the controllable switches 462a-462f and the controllable switches 462a-462f open. As a result, the voltage at the gate of each SCR 453a-453f drops, the SCRs 453a-452f turn off, and current cannot flow through the wye points 324a, 324b, 324c or the filter capacitors 314a, 314b, 314c of the filtering circuit 310. Thus, loss from circulating currents that would otherwise flow in the filter capacitors 314a, 314b, 314c when the matrix converter 302 is in the INACTIVE state is reduced or eliminated by the damping-disconnect circuit 550.

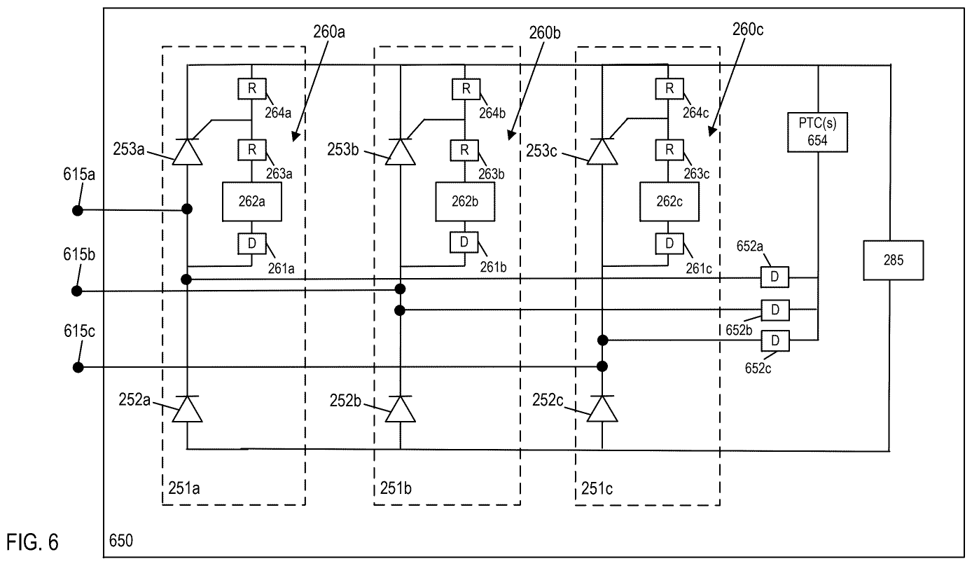

FIG. 6 is a schematic of another damping-disconnect circuit 650. In high power applications (for example, 100 kilowatts (kW) and greater), the value of the damping resistance and on-state resistances of the main semiconductors may be small resulting in a non-trivial current surge on power up of the power converter or matrix converter. The damping-disconnect circuit 650 may be used to mitigate this current surge.

The damping-disconnect circuit 650 is similar to the damping-disconnect circuit 250 (FIG. 2B), except the damping-disconnect circuit 650 also includes diodes 652a, 652b, 652c and a positive temperature coefficient (PTC) circuit 654 including at least one PTC thermistor. The damping-disconnect circuit 650 includes damping-disconnect circuit input nodes 615a, 615b, 615c. The cathodes of the diodes 652a, 652b, 652c are electrically coupled to the thermistor circuit 654. The damping-disconnect circuit input node 615a is connected between the diode 252a and the SCR 253a, the damping-disconnect circuit input node 615b is connected between the diode 252b and the SCR 253b, and the damping-disconnect circuit input node 615c is connected between the diode 252a and the SCR 253c.

In operational use, the damping-disconnect circuit 650 is electrically connected to a filter circuit to reduce or eliminate circulating currents. For example, the damping-disconnect circuit 650 may be used in the system 200 instead of the damping-disconnect circuit 250. In this example, the damping-disconnect circuit input node 615a is connected to the capacitor 214a, the damping-disconnect circuit input node 615b is connected to the capacitor 214b, and the damping-disconnect circuit input node 615c is connected to the capacitor 214c.

During power-up of the power converter 202 and before the control system 280 outputs a READY signal 281 to the damping-disconnect circuit 650, the SCRs 253a, 253b, 253c of the semiconverter circuits 251a, 251b, 251c are off. Nevertheless, a current begins to flow though the diodes 652a, 652b, 652c, the PTC circuit 654, the damping resistance 285, and the diodes 252a, 252b, 252c. The initial current depends, for example, on the value of the PTC thermistor(s) in the PTC circuit 654 and the value of the damping resistance 285. As current flows through the PTC circuit 654, the impedance of the PTC thermistor(s) in the PTC circuit 654 increases significantly, thereby reducing the current through the PTC circuit 654 (for example, to the mA range) and severely attenuating the circulating current through the filter capacitors 214a, 214b, 214c and the source-side inductors 212a, 212b, 212c. When the control system 280 outputs the READY signal 281 to the damping-disconnect circuit 650, the controllable switches 262a, 262b, 262c and the SCRs 253a, 253b, 253c turn on and current flows through the SCRs 253a, 253b, 253c. As a result, the SCRs 253a, 253b, 253c bypass the PTC circuit 654 and current flows through the damping resistance 285. Effective damping, which is dependent on the value of the damping resistance 285 and the value of the components of the filtering circuit 210, is thus provided. At the end of a process or shift or schedule, when the power converter 202 is turned OFF or placed in an INACTIVE state, the control system 280 removes the READY signal 281 and the controllable switches 262a, 262b, 262c and the SCRs 253a, 253b, 253c turn off.

In a similar manner, the diodes 652a, 652b, 652c and the PTC circuit 654 may be incorporated into the damping-disconnect circuit 350 (FIG. 3B) to reduce the circulating current through the filter capacitors 314a, 314b, 314c and source-side inductors 312a, 312b, 312c when the matrix converter 302 (FIG. 3A) is in an INACTIVE state. The PTC circuit 654 may be incorporated into the damping-disconnect circuits 450 (FIG. 4) and 550 (FIG. 5) to reduce the circulating current through the corresponding filter capacitors.

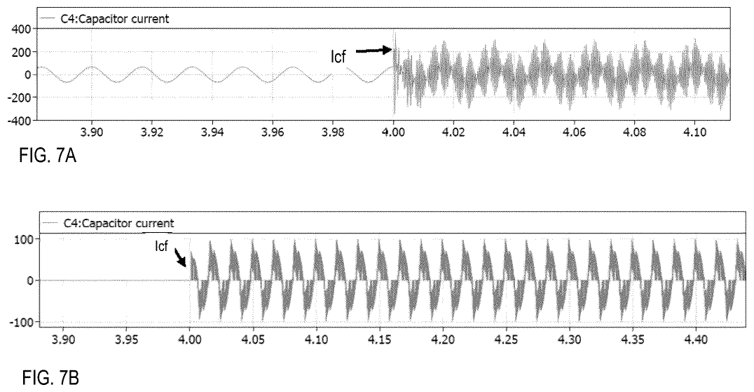

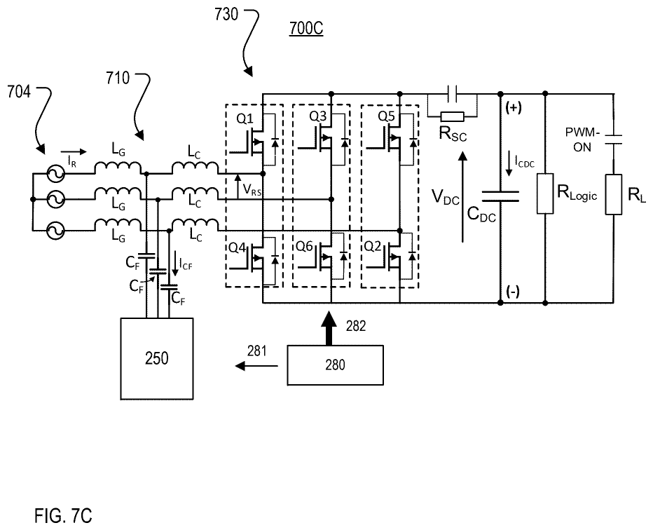

FIGS. 7A and 7B show simulated results of a system 700C. FIG. 7C is a schematic of the system 700C. FIG. 7A shows current flow in the filter capacitor Cf (Icf) in amperes (A) as a function of time in seconds(s) when the damping-disconnect circuit 250 is not used in the system 700C. FIG. 7B shows the amount of current (Icf) as a function of time when the damping-disconnect circuit 250 is used in the system 700C.

Referring to FIG. 7C, the system 700C includes an active front end (AFE) 730 and an AC source 704. The active front end 730 is connected to the AC source 704 through a three-phase filter system 710. The filter system 710 is similar to the filter circuit 210 (FIG. 2A). Each phase of filter system 710 includes a grid side inductor (Lg), a converter side inductor (Lc), and a filter capacitor Cf connected to the inductors Lg and Lc. The AFE 730 is connected to a soft charge resistance Rsc and a DC link that includes a capacitor Cdc. The system 700C also includes the damping-disconnect circuit 250.

In the simulation, each grid side inductor Lg was 50 microhenries (μH), each converter side inductor Lc was 0.25 mH, each filter capacitor Cf was 450 microfarads (μF). The switching frequency (Fsw) of the transistors in the AFE 730 when controlled in a switching pattern was 2 kilohertz (kHz). The capacitance of the DC link capacitor Cdc was 20.4 millifarads (mF). The soft charge resistance (Rsc) was 60 ohms (Ω). A logic load (Rlogic) was represented as 5 kΩ, 90 watts (W), and a partial load (RL) was represented as 100 Ω, 4.9 kW. The damping resistance 285 of the damping-disconnect circuit 250 was 6Ω. Table 1 below summarizes the parameters used in the simulation.

TABLE 1

| | |
|---|---|
| Component Description | Value |

| | | |
|---|---|---|
| Grid side inductor, Lg | 50 | μH |
| Converter side inductor, Lc | 0.25 | mH |
| Filter Capacitor, Cf | 450 | μF |
| Switching Frequency, Fsw | 2 | kHz. |

| | |
|---|---|
| Total main DC Bus Capacitor, Cdc | 20.4 mF, 900 V |
| Pre-charge Resistor, Rsc | 60Ω |
| Load Resistor to represent logic load, R_{Logic} | 5 kΩ, 90 W |
| Load Resistor to represent partial load, R_{L} | 100Ω, 4.9 kW |

Referring to FIGS. 7A and 7B, the damping-disconnect circuit 250 was not connected to the filter capacitors Cf to produce the data shown in FIG. 7A and the damping-disconnect circuit 250 was connected to the filter capacitors Cf to produce the data shown in FIG. 7B. Thus, the action of the damping-disconnect circuit 250 is seen by comparing the data in FIG. 7A to that in FIG. 7B.

During the simulation, the AFE 730 was in the INACTIVE state until t=4 s, when the controls system 280 provided the PWM control signal 282 to the AFE 730. In other words, the AFE 730 transitioned from the INACTIVE state to the ACTIVE state at the time t=4 s. As shown in FIG. 7A, when the damping-disconnect circuit 250 is not connected to the filter circuit 710, current flowed through the filter capacitors Cf when the AFE 730 was in the INACTIVE state (the times before t=4 s) and when the ACTIVE state. On the other hand, as shown in FIG. 7B, when the damping-disconnect circuit 250 is connected to the filter circuit 710, current did not flow in the filter capacitors Cf prior to t=4.00. By preventing current from flowing in the filter capacitors Cf while the AFE 730 was in the INACTIVE mode, the damping-disconnect circuit 250 reduced the overall loss and heat dissipation of the system 700C.

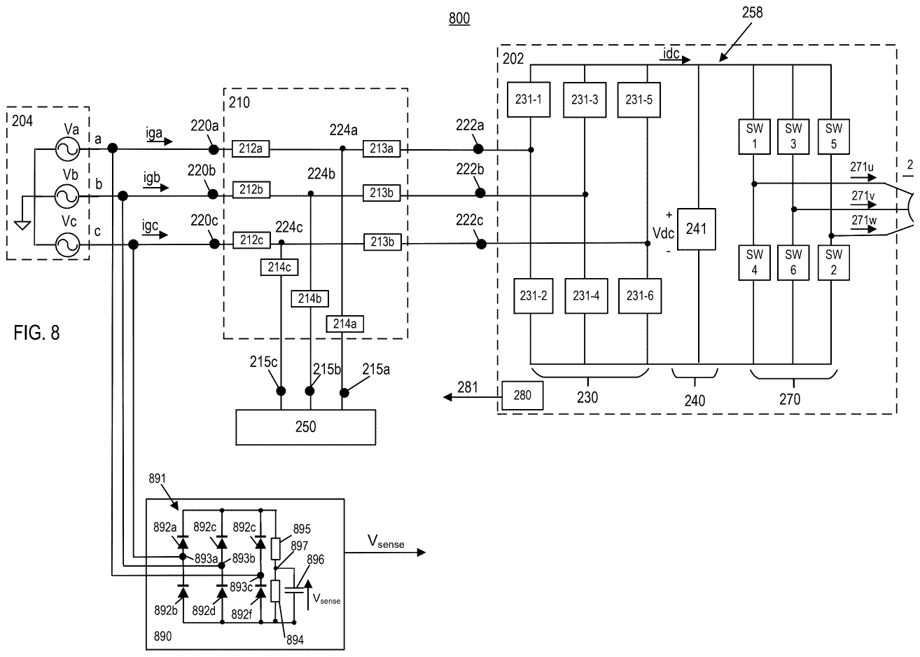

Referring to FIG. 8, a health monitoring circuit 890 may be used to monitor the health of an AC source connected to a power converter. FIG. 8 is a schematic of a system 800 that includes the power converter 202, which is connected to the AC source 204 through the filtering circuit 210, and the health monitoring circuit 890, which is connected to the AC source 204. The health monitoring circuit 890 may be used to monitor the health of the AC source 204. For example, the health monitoring circuit 890 may be used to determine if the AC source 204 is experiencing a fault condition or other circumstance that could affect the power converter 202 such that mitigating action may be taken. For example, it may be prudent to turn off the power converter 202 when the AC source 204 has a fault condition so that the power converter 202 does not feed the fault condition.

The health monitoring circuit 890 includes a three-phase rectifier 891 electrically coupled to the three phases a, b, c of the AC source 204. The three-phase rectifier 891 is configured to convert the three-phase AC current from the AC source 204 to a DC current. The three-phase rectifier 891 includes a first branch with diodes 892a, 892b electrically connected in series, a second branch with diodes 892c, 892d electrically connected in series, and a third branch with diodes 892e, 892e electrically connected in series. The health monitoring circuit 890 also includes a voltage divider formed by resistances 894, 895 electrically connected to the output of the rectifier 891, and a capacitor 896 that is electrically connected to a node 897 between the resistances 894, 895.

To connect the health monitoring circuit 890 to the system 800 such that the health of the AC source 204 can be monitored, phase a of the AC source 204 is electrically connected to a node 893a between the diodes 892a, 892b; phase b of the AC source 204 is electrically connected to a node 893b between the diodes 892c, 892d; and phase c of the AC source 204 is electrically connected to a node 893c between the diodes 892e, 892f. The value of the voltage at node 897 of the voltage divider formed by resistances 804, 805 and across the capacitor 896 is proportional to and is an indication of the voltage of the AC source 204 and is referred to as Vsense.

The health monitoring circuit 890 may be used to monitor the AC source in any system that includes a power converter. For example, the health monitoring circuit 890 may be used with the system 300.

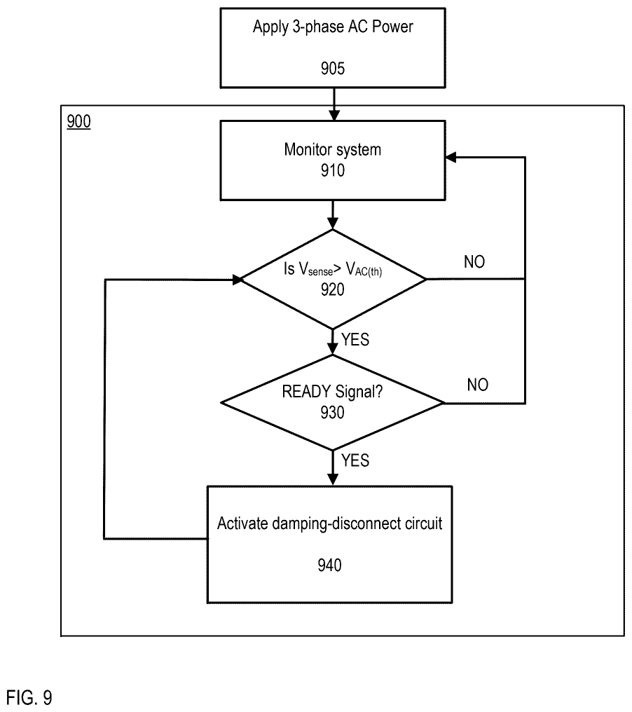

FIG. 9 is a flow chart of a process 900. The process 900 is an example of a process for controlling the SCRs in a damping-disconnect circuit. The process 900 may be implemented as machine-executable instructions and/or software that are stored on the electronic storage 284 and executed by the electronic processing module 283. The process 900 is discussed with reference to the system 800 of FIG. 8 but may be used with other systems.

The AC source 204 provides three-phase AC power to the power converter 202 while the power converter 202 is in an OFF or INACTIVE state (905). In implementations in which the damping-disconnect circuit includes a PTC circuit (such as the PTC circuit 654 of FIG. 6), circulating current in the filter circuit 210 flows through the PTC circuit 654. As discussed above, the PTC circuit 654 heats up and provides a very high impedance in response to the flow of the circulating current, thereby substantially attenuating the circulating current. In implementations in which the damping-disconnect circuit does not include a PTC circuit, the SCRs 253a, 253b, 253c of the damping-disconnect circuit 250 are OFF and current does not flow in the filter capacitors 214a, 214b, 214c.

The process 900 begins and the system 200 is monitored (910). For example, the voltage Vsense is accessed or obtained by the control system 280. The voltage Vsense is the voltage across the capacitor 896 (FIG. 8) and is a measured value. The value of Vsense may be measured by a voltage sensor and provided to the control system 280. In some implementations, the value of the current flowing in the resistance 895 and/or 896 is measured and provided to the control system 280, which determines the value of Vsense from the measured current value. The control system 280 may poll the measurement sensor to access the measured data or the measurement sensor may send the data to the control system.

The voltage Vsense is compared to a voltage threshold (Vac_thresh) to determine whether the AC source 204 is in a healthy condition (920). The voltage threshold (Vac_thresh) is a predetermined voltage value that may be stored on the electronic storage 284. The voltage threshold (Vac_thresh) is a value that is the lower bound of the voltage expected at the source 204. For example, the voltage threshold (Vac_thresh) may be a value that, below which, the AC source 204 is experiencing a fault condition such as a brown-out condition. If the value of Vsense is less than or equal to the voltage threshold (Vac_thresh), the AC source 204 is not determined to be healthy, and the SCRs 253a, 253b, 253c of the damping-disconnect circuit 250 remain OFF and the process 900 returns to (910) and continues to monitor the system 200. The power converter 202 remains in an OFF or INACTIVE state.

If the value of Vsense is greater than the voltage threshold (Vac_thresh), the AC source 204 is determined to be healthy and the process 900 advances to (930) to determine whether the READY signal 281 is present. As discussed above, the control system 280 produces the READY signal 281 when the power converter 202 is in the ACTIVE state and the control system 280 is controlling the switches 231-1 to 231-6 based on a switching pattern defined in the control signal 282. The READY signal 281 is present, for example, when an operator of the power converter 202 places the power converter 202 in a run or operating state at the beginning of a shift or the beginning of a week.

If the READY signal 281 is present, the control system 280 activates the damping-disconnect circuit 250 (940). To activate the damping-disconnect circuit 250, the control system 240 provides the READY signal 281 or a trigger signal to the damping-disconnect circuit 250 to cause the controllable switches 262a, 262b, 262c to turn ON such that the SCRs 253a, 253b, 253c in the damping-disconnect circuit 250 also turn ON. Current flows through the SCRs 253a, 253b, 253c and into the damping resistance 285 while the power converter 202 operates in a steady state manner.

The process 900 returns to (920) periodically during steady state operation to continue to monitor the health of the AC source 204 and to continue to determine that the READY signal is present. The controllable switches 262a, 262b, 262c and SCRs 253a, 253b, 253c of the damping-disconnect circuit 250 are ON when the AC source 204 is healthy (Vsense>Vac_thresh) and the READY signal 281 has been generated. If there is a fault or other health condition in the AC source 204 (Vsense<Vac_thresh) and/or if the power converter 202 is in an OFF or INACTIVE state with no READY signal being issued by the control system 280, the controllable switches 262a, 262b, 262c and the SCRs 253a, 253b, 253 are turned off or stay off such that any circulating current prevented from flowing in the filter capacitors or is significantly attenuated (if the PTC circuit 654 is present (FIG. 6)).

These and other implementations are within the scope of the claims.

What is claimed is:

1. A system comprising:
a filter apparatus comprising a plurality of phases, each phase of the filter apparatus comprising: a first node, a second node, and a filter circuit between the first node and the second node, wherein each first node is configured to electrically connect to one phase of a multi-phase alternating current (AC) electrical power source, and each filter circuit comprises a capacitive network;
a power converter electrically connected to the second nodes and configured to produce an output when in an ACTIVE state and to not produce the output when in an INACTIVE state; and
a damping-disconnect circuit electrically connected to the filter apparatus and configured to reduce a circulating current in the filter circuit, the damping-disconnect circuit comprising a plurality of silicon-controlled-rectifiers (SCRs), each SCR coupled to the capacitive network of one filter circuit.

2. The system of claim 1, wherein the plurality of SCRs transition from an OFF state to an ON state in response to the power converter transitioning from the INACTIVE state to the ACTIVE state.

3. The system of claim 2, wherein the damping-disconnect circuit further comprises a plurality of switches, each of the plurality of switches electrically connected to a gate of one of the plurality of SCRs, and wherein each of the plurality of switches is open when the electrical network is in the INACTIVE state and each of the plurality of switches closes in response to the electrical network transitioning to the ACTIVE state to thereby turn on the plurality of SCRs.

4. The system of claim 3, wherein each switch comprises a mechanical contactor.

5. The system of claim 3, wherein each switch comprises an SCR.

6. The system of claim 1, wherein the damping-disconnect circuit further comprises a plurality of diodes, each of the plurality of diodes electrically connected to an anode of one of the SCRs.

7. The system of claim 1, wherein the power converter is configured to convert alternating current (AC) to direct current (DC) and to convert DC current to AC current.

8. The system of claim 1, wherein the power converter comprises an active front end (AFE) and an inverter.

9. The system of claim 1, wherein the power converter comprises a matrix converter.

10. The system of claim 1, wherein the damping-disconnect circuit further comprises a damping resistance.

11. The system of claim 10, wherein the damping resistance comprises a plurality of damping resistances, and each of the plurality of damping resistances is electrically connected to one of the capacitive networks and at least one of the SCRs.

12. The system of claim 11, wherein each of the plurality of damping resistances is electrically connected between one of the capacitive networks and one of the SCRs.

13. The system of claim 10, wherein the damping resistance comprises a plurality of damping resistances and each filter circuit further includes an inductive network, and wherein each of the plurality of damping resistances is electrically connected in parallel to one of the inductive networks.

14. The system of claim 1, further comprising a control apparatus configured to output a trigger signal to the damping-disconnect circuit to actuate a plurality of switches to thereby turn on the SCRs in response to an operational status of the power converter.

15. The system of claim 14, wherein the control apparatus is configured to output the control signal to the damping system when the power converter is transitioned to the ACTIVE state.

16. The system of claim 1, wherein the damping-disconnect circuit is configured to prevent current from flowing in the filter circuits when the electrical network is in the INACTIVE state.

17. The system of claim 1, wherein the damping-disconnect circuit further comprises a positive temperature coefficient circuit configured to attenuate current flowing in the filter circuits when the electrical network is in the INACTIVE state.

18. A system comprising:
a damping-disconnect circuit configured for connection to a filter circuit of a power converter, the damping-disconnect circuit comprising:
a plurality of silicon-controlled-rectifiers (SCRs), each SCR configured to be electrically connected to a capacitive network in one phase of a multi-phase filter apparatus; and
a plurality of switches, each switch configured to turn ON a respective SCR of the plurality of SCRs in response to a trigger signal, wherein the damping-disconnect circuit is configured to eliminate or attenuate circulating current in the filter circuit.

19. The system of claim 18, wherein the damping-disconnect circuit further comprises at least one damping resistor configured to dissipate the circulating current.

20. A control system configured to:
determine whether an alternating current (AC) source electrically connected to a filter circuit of a power converter is in a fault condition;
if the AC source is not in a fault condition, determine whether the power converter is in a READY state;
if the power converter is in the READY state, causing a thyristor in the damping-disconnect circuit to be ON such that current from the filter circuit flows in the damping-disconnect circuit; and
if the power converter is not in the READY state, causing the thyristor in the damping-disconnect circuit to be OFF.
